(19) United States
(12) Patent Application Publication
(10) Pub. No.: US 2025/0307904 A1
(43) Pub. Date: Oct. 2, 2025

(54) MERCHANT WEBSITE FEATURING RELATED THIRD-PARTY PRODUCTS OF MULTIPLE COMPANIES PURCHASED WITH A SINGLE TRANSACTION

(71) Applicant: MNO Marketing & Design LLC d/b/a Derm Resource Group, Dallas, TX (US)

(72) Inventor: Jay T. Oyakawa, Dallas, TX (US)

(21) Appl. No.: 19/095,977

(22) Filed: Mar. 31, 2025

Related U.S. Application Data
(60) Provisional application No. 63/571,779, filed on Mar. 29, 2024.

(51) Int. Cl. G06Q 30/0601; G06Q 10/083; G06Q 20/38

(52) U.S. Cl. CPC G06Q 30/0635; G06Q 10/083; G06Q 20/38; G06Q 30/0617; G06Q 30/0641

(57) ABSTRACT

A multi-merchant architecture website allows a customer to make online purchases of multiple products from different companies with a single online transaction. The companies may sell products that are third-party products sold by a merchant on the merchant's website and related to the merchant's primary business. The single transaction includes a total transaction cost that is allocated among the multiple companies. Each company fulfills the purchase of their products.

### CROSS-REFERENCE TO RELATED APPLICATIONS

The present application claims priority from, and incorporates by reference in its entirety, U.S. provisional patent application 63/571,779 filed Mar. 29, 2024.

### TECHNICAL FIELD

The present disclosure relates to internet commerce, and more particularly, to merchant websites advertising their products and services.

### BACKGROUND

Nearly all businesses today have a website that advertises their products or services and provides contact information. Maintaining a website makes it convenient for a prospective client to establish contact with a business with only a few keystrokes. Even if a prospective client knows the name of a particular business, it is generally easier to do an internet search for the website of the business, rather than trying to find its contact information in a directory listing.

Quite a few businesses use third-party parts or supplies as part of their own business. For example, a locksmith might sell the batteries that are used in car key fobs even though selling batteries is not the primary business of a locksmith. Customers of the locksmith may find it convenient to purchase their car key fob batteries from their locksmith rather than determining which type of battery to buy from among the dozens of types of button cell batteries available. If a merchant does sell third-party products as part of their business, then they may also advertise the third-party products for sale on their website as well.

Nearly all business have their own merchant website to describe and advertise their business. Some businesses sell their products and/or services directly through their merchant website. It is becoming increasingly common for businesses to also sell third-party products/supplies that are related to their business through their merchant website.

The present inventor recognized that, while some businesses have a need to advertise third-party products on their own merchant website, selling those third-party products gives rise to several issues and drawbacks. Selling third-party products requires keeping inventories and records, and dealing with returns and possibly product liability. Thus, while a business might want to list a recommended product on their website, they may prefer to not actually fulfill the sale of the product. In some situations the business may sell the product, but only as required in their primary line of work. For example, a locksmith might sell button cell batteries only in replacement keyfobs that the locksmith sells. The locksmith may prefer not to sell button cell batteries by themselves as replacement parts.

For some businesses it is preferable to show the recommended product on their website but not sell the product at their place of business or by mail. Other businesses may sell a third-party product required as part of their primary business, but may opt not to sell replacement parts or supplies directly to clients from their place of business. For example, a medical clinic may provide bandages or gauze as part of wound care, but may prefer not to sell the bandages or gauze for the patient to take home even though they will soon be needed. Even if bandages, gauze or other supplies or replacement parts are not sold directly to clients at the place of business, most merchants would benefit by selling them online through their website.

Aesthetic providers—e.g., dermatologists, medical spas, plastic surgeons and wellness clinics—are medical practices that may especially benefit from selling third-party products through their own websites. Aesthetic providers have a greater tendency to be cash-based businesses than many other medical practices. While some plastic surgeons and dermatologists routinely perform insurance-based services, most payments to aesthetic providers are directly from patients paying in cash or by credit card payment. Further, the aesthetic medicines, creams, salves, bandages and other aesthetic medical supplies tend to be high margin products. As such, aesthetic providers in this space are becoming more innovative in adapting their businesses to service their cash wielding patients, including business tactics like having an online store.

Other forms of payments in the aesthetic provider space that can also be used to purchase third-party products include patient financing from companies like CareCredit®, Patient Fi, Cherry, Greensky®, Alphaeon®, PayPal®, and Affirm, or the like. These companies are actively entering the financing of patient services in the aesthetic space which also comprises manners in which providers are being paid today. Providers also receive payments from third party manufacturers like Alle and Aspire, which are consumer loyalty programs centered around patient loyalty programs from companies like Allergan and Galderma.

Many merchants with a website, such as medical providers in the aesthetic space, use online stores on their own merchant website to sell products and services offered by the practice to their existing patients and also to attract new patients. Conventionally, since most of the items are provided from the medical provider's inventory, the online store is generally limited to services like Botox® and facials and retail products like skincare, supplements, and medical devices like a facial scrub brush or LCD mask that may be used as part of an anti-aging or skincare regimen that is already in the inventory of the provider's practice.

There has been a rise of providers in this space, and services like Shop My Shelf where the business is an affiliate to the website and is paid a commission. This situation where an affiliate makes the sale and takes a commission is called the affiliate model (or sometimes called affiliate program). One scenario of an affiliate model in the aesthetics space is where a doctor or medical practice places an affiliate link on their own website to a skincare manufacturer's online store. The affiliate link redirects a patient seeking a skincare product to the manufacturer's site. This scenario—redirecting customers to a manufacturer website (or to an affiliate seller like Shop My Shelf)—may be referred to as a manufacturer affiliate program. Typically, for a manufacturer affiliate program the referring doctor's website tracks the patient to create an affiliate tracking code in an effort to ensure payment. The situation where a customer is instead directed to an online store of a website developer is called a developer affiliate model (or developer affiliate program). The website developer has a relationship with the merchant—e.g., a medical practice—inasmuch as the website developer creates and/or maintains the merchant website for the merchant.

### SUMMARY OF THE INVENTION

Various embodiments of the present disclosure can overcome various of the aforementioned drawbacks and offers other advantages as well.

According to various embodiments of the present disclosure there is provided a multiple-brand internet online shopping system stored on one or more non-transitory computer readable storage mediums, the system having a micro-store configured on a host webstore, the micro-store including a first description of a first product offered for sale to a user for a first price, wherein the first product is produced by a first company; a second description of a second product offered for sale to the user at a second price, wherein the second product is a third-party product produced by a second company; an on-line cart configured as part of the host webstore, where the on-line cart is configured to display an order including a first listing of the first product being purchased and a second listing of the second product being purchased, the on-line cart also displaying a total order cost including the first price of the first product and the second price of the second product; a checkout page prompting the user to make a purchase-input to execute a single transaction for the total order cost as payment for the first product and the second product; and an allocation calculator configured to allocate a first portion of the total order cost to the first company and a second portion of the total order cost to the second company.

In some forms, the system of includes a merchant website of a merchant business, the merchant website including a listing of the first product offered for sale at the first price, wherein the first product is a third-party product of the merchant business.

In some forms, a first link on the merchant website included in the listing of the first product, the first link being configured to redirect the user to the micro-store on the host webstore.

In some forms, the micro-store is a web developer micro-store.

In some forms, a landing page configured as part of the web developer micro-store, wherein the landing page has identifying information of the merchant.

In some form the total order cost includes a first shipping cost for shipping the first product from the first company to the user and a second shipping cost for shipping the second product from the second company to the user.

In some forms, the single transaction results in a first credit card payment to the first company and a second credit card payment to the second company.

In some forms, the system includes a cart page prompting the user to enter user information including a user name and user shipping address.

In some forms, the system includes a first package containing the first product sent from the first company to the user at the user shipping address; and a second package containing the second product sent from the second company to the user at the user shipping address.

In some forms, a method of multiple-brand internet online shopping is provided, including configuring a micro-store as part of a host webstore, the micro-store including a first description of a first product offered for sale to a user for a first price, wherein the first product is produced by a first company; including a second description of a second product offered for sale on-line to the user at a second price, wherein the second product is a third-party product produced by a second company; configuring an on-line cart as part of the host webstore, the on-line cart being configured to display an order including a first listing of the first product being purchased and a second listing of the second product being purchased, the on-line cart also displaying a total order cost including the first price of the first product and the second price of the second product; prompting the user a checkout page to make a purchase-input; executing a single transaction in response to the purchase-input for the first product and the second product, the single transaction including the total order cost as payment for the first product and the second product; and locating a first portion of the total order cost to the first company and a second portion of the total order cost to the second company.

In some forms, a merchant website of a merchant business is provided, the merchant website including a listing of the first product offered for sale at the first price, wherein the first product is a third-party product of the merchant business. In some forms, a first link on the merchant website is provided, the first link being included in the listing of the first product and is configured to redirect the user to the micro-store on the host webstore. In some forms, the host webstore is a web developer host webstore.

In some forms, a landing page is configured as part of the web developer host webstore, and identifying information of the merchant is provided on the landing page. In some forms, the total order cost includes a first shipping cost for shipping the first product from the first company to the user and a second shipping cost for shipping the second product from the second company to the user. In some forms, the single transaction results in a first credit card payment to the first company and a second credit card payment to the second company.

In some forms, the single transaction results in a single credit card payment to the host webstore, and the host webstore sends the first portion of the single payment to the first company and sends the second portion of the single payment to the second company. In some forms, the user is prompted to enter user information at a cart page, the user information including a user name and user shipping address.

In some forms, a first package containing the first product is sent from the first company to the user at the user shipping address; and a second package containing the second product is sent from the second company to the user at the user shipping address.

### BRIEF DESCRIPTION OF THE DRAWINGS

Various aspects and advantageous features of the present disclosure will become more apparent to those of ordinary skill in the art from the explanations in the Detailed Description below, and reference to the accompanying drawings, wherein:

FIG. 1A depicts relationships between a merchant website and a host webstore that includes micro-stores, in accordance with various embodiments.

FIG. 1B depicts an example screenshot of a doctor's merchant website showing links to micro-stores of various skincare manufacturers contained in a host webstore, in accordance with various embodiments.

FIG. 1C depicts a typical landing page for a merchant website provided in a host webstore, according to various embodiments.

FIG. 1D depicts an example screenshot of different brands listed on a merchant website, in accordance with various embodiments.

FIG. 2A depicts a screenshot of a product advertisement in an online merchant store of a merchant website, according to various embodiments.

FIG. 2B depicts a screenshot of a product displayed at the manufacturer's micro-store within a host webstore, in accordance with various embodiments.

FIG. 3A depicts an online shopping cart screenshot of a customer purchasing multiple products from different manufacturers through the multi-merchant architecture of a host webstore, according to various embodiments.

FIG. 3B depicts an example order acknowledgement screenshot for products from different manufacturers, in accordance with various embodiments.

FIG. 4 depicts an example architecture suitable for use in practicing the invention, in accordance with various embodiments.

FIG. 5 is a flowchart of a method of multi-company single-transaction purchase, in accordance with various embodiments.

### DETAILED DESCRIPTION

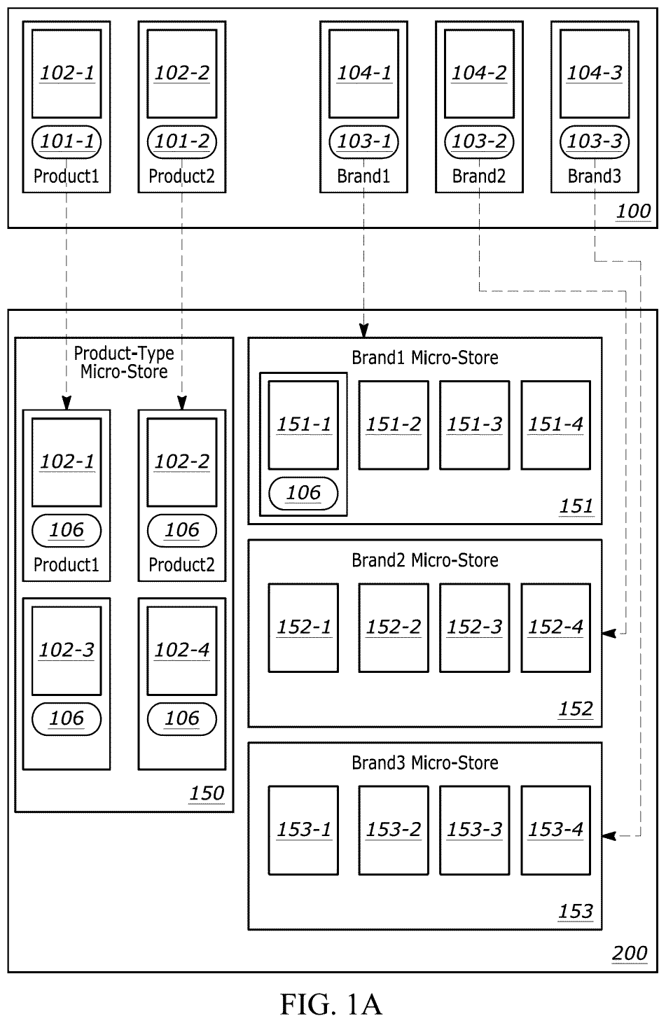

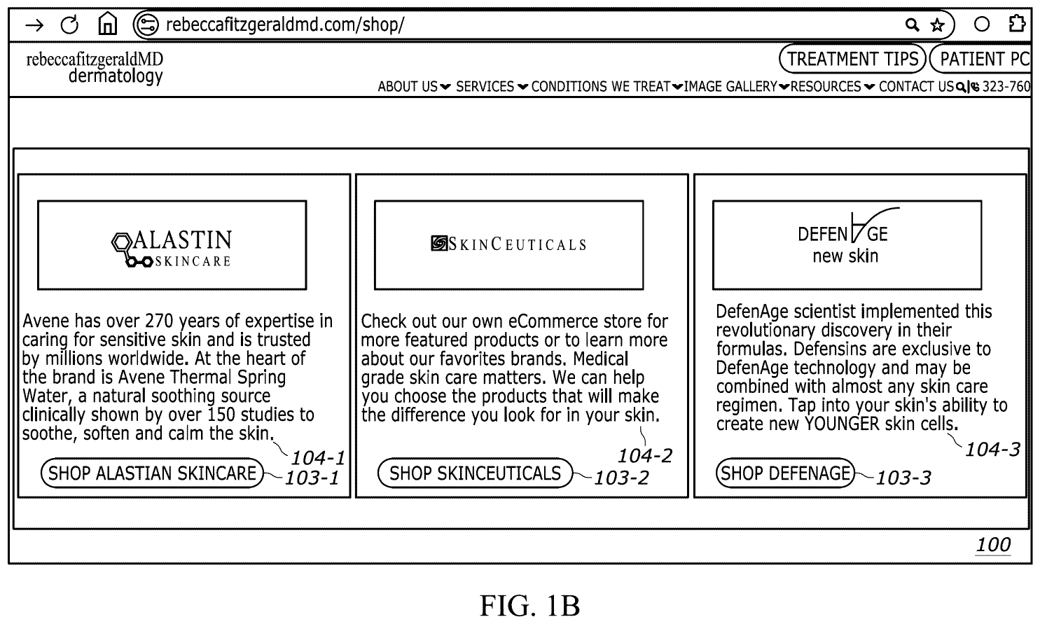

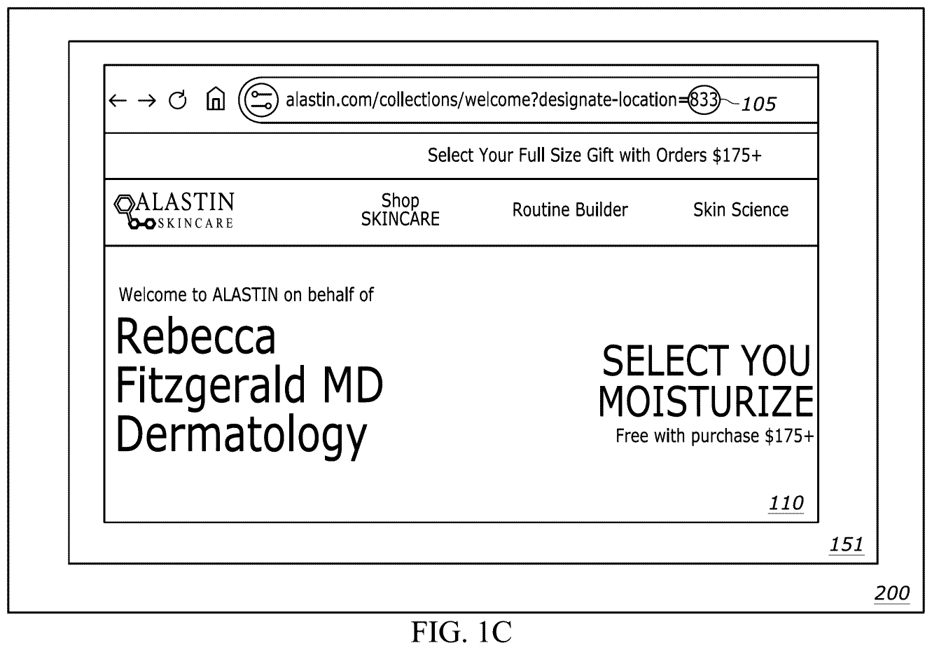

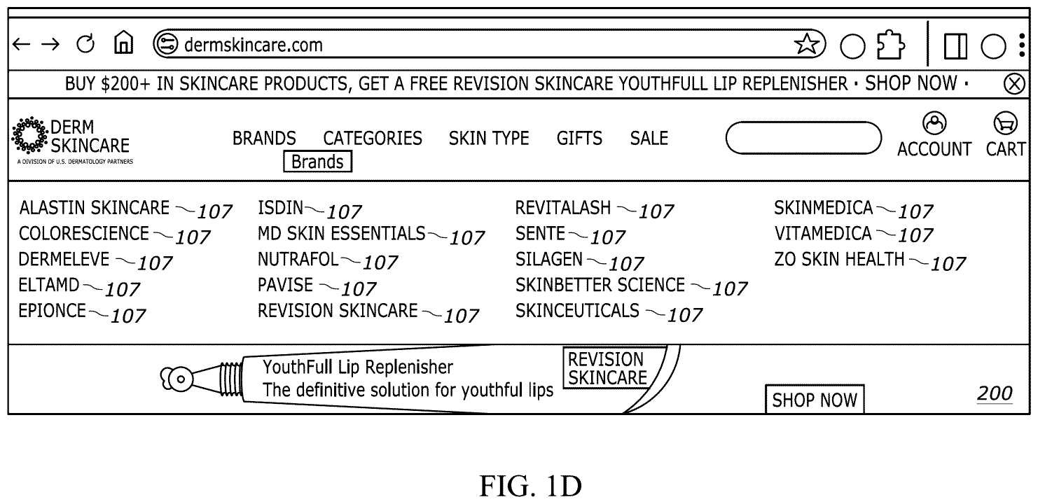

FIG. 1A depicts relationships between a merchant website 100 and a host webstore 200 that includes micro-stores 150 and 200, in accordance with various embodiments. A merchant website 100 may feature third-party products for sale by displaying product information 102-1. Product information 102-1 typically includes information such as the product name, a picture of the product, the price, the name and/or logo of the company that produces the product, and sometimes information about usage of the product, product features, ingredients or other details that may be of interest to a potential buyer of the product.

If a customer (e.g., a patient) clicks the product link 101-1 for a particular product displayed on merchant website 100, as shown on FIG. 1A, the customer may be redirected from the merchant website 100 to a host webstore 200 that sells the product. The listing on the host webstore 200 may be in a micro-store 150 that features a number of similar products produced by different brands (or companies). For example, Product1 and Product2 sold in Product-type Micro-store 150 are both the same type of product. Product1 may be a wrinkle cream made by one company while Product2 could be the wrinkle cream made of another company.

A merchant website 100 may also feature one or more brand listings (or companies)—e.g., Brand1, Brand2 and Brand3, as shown on FIG. 1A. Typically, the various brands (or companies) displayed on a merchant website 100 are brands that sell the third-party products related to the merchant's main line of business. Each of the brand listings generally has a brand-description of the brand. For example, the Brand1 brand listing includes brand-description 104-1, the Brand2 brand listing includes brand-description 104-2, and the Brand3 brand listing includes brand-description 104-3. As shown in FIG. 1A, if a customer clicks brand-link 103-1 associated with Brand1 as display in merchant website 100, the customer will be redirected from the merchant website 100 to a host webstore 200 that includes a micro-store 151 that sells the various products of the Brand1 company. FIG. 1B depicts an example screenshot of a portion of a merchant website 100 for an aesthetic medical practice—e.g., a dermatologist, plastic surgeon, skin care medical clinic, or the like—that features various brands. The merchant website 100 includes descriptive brand-information for each brand (104-1 through 104-3) and associated brand-links (103-1 through 103-3). Each of the brand-links 103-1 through 103-3 redirects a customer to a micro-store within a host webstore 200 dedicated to the brand selected. For example, if a customer clicks the Alastin Skincare brand-link 103-1, the customer will be redirected to the Alastin Skincare micro-store within a host webstore 200—such as micro-store 151 shown in FIG. 1A.

Turning again to FIG. 1A, in some implementations if a customer clicks on a product link 101-1/2 for a particular product or clicks on a displayed on merchant website 100 or clicks on a brand-link 103-1 through 103-3 associated with a particular brand, the customer is redirected from the merchant website 100 to a micro-store that sells the product such as micro-store 150-or to a micro-store that sells products of a particular brand 151 through 153. For example, a customer seeking to buy an Alastin® skincare product shown on a doctor's merchant website 100 of FIG. 1B may be redirected to the Alastin® skincare products micro-store 151 configured as part of host webstore 200 shown in FIG. 1C.

The host webstore 200 to which the customer is redirected may provide a landing page 110, as shown in FIG. 1C, that identifies the doctor's website (or other site linked to the landing page 110). The landing page 110 helps to make the customer who is being redirected feel like there is continuity to the prior merchant website 100 they were browsing and the host webstore 200 to which they were redirected. The host webstore 200 may use attribution data 105 to keep track of customers who were redirected from a merchant website 100. In this way the merchant website 100 can be credited with the sale and paid a commission. The attribution data 105 may take the form of a location ID placed in the URL to identify the inbound traffic redirected from the merchant website 100. If a sale results from the redirected customer, the location ID can be used as attribution data 105 to credit the owner of the merchant website 100—e.g., the referring physician's website—for the purposes of paying a commission.

The present inventor recognized several benefits to doctors and other merchants using affiliate programs. These benefits include not needing to maintain a product inventory or ship the product. Maintaining inventory and shipping products is considered burdensome to many providers or other merchants who see it as time-consuming and non-essential to their core business. The doctor or other merchant can limit the amount of inventory they are required to carry on-site by directing all the fulfillment directly to the brand (e.g., a company or manufacturer), thus allowing such items to be shipped by the brand. Another benefit is that the website of the host webstore 200 may allow the customer to select from many more items than are typically carried on a merchant website 100 such as a skincare provider or medical practice. This benefits the merchant since they can receive commissions on purchases made to customers who are redirected from their site.

In the aesthetic space, each skincare manufacturer tends to focus on critical areas of skincare, like anti-aging, vitamin C products, or sunscreen lotions. Another benefit of affiliate programs, as recognized by the present inventor, is that providers can carry a small number of hero products (products with the greatest sales volume) related to their practice—or even just carry the single most popular product of a particular skincare manufacturer. The doctor's merchant website need not carry the entire list of SKUs for a given manufacturer of skincare products, which could be dozens of products in total—significantly more than the top handful of hero products for each skincare manufacturer.

FIG. 1D depicts an example screenshot 200 of different product brands 107 listed on a host webstore 200, in accordance with various embodiments. A typical merchant—e.g., a medical practice—in this space may carry several different product brands 107 on their own merchant website 100, but only list the top selling product(s)—the hero products—identified by SKU, for the product brands 107 that they display. Redirecting the customer from the merchant website 100 to a host webstore 200 allows the customer to browse all SKUs of a skincare manufacturer, which is seen as a benefit for the affiliate models. This is partly correlated to minimizing inventory for the providers in this space.

Bundling with services is a tactic found to be advantageous in the aesthetic provider space as well. An aesthetic medical practice may offer a bundle for a service like HydraFacial® or Botox® with a particular skincare product. By unbundling the services and product sale process, affiliate models create different sales channels and processes that undermine many common tactics today. Not being able to offer a Botox® special with your favorite skincare brand for a high-volume sales day such as Black Friday or a Fall Sales Event undermines the tactics many providers in the aesthetic provider space embrace as part of their marketing efforts.

The present inventor considered the various benefits and challenges of an affiliate model for providing the ability to service a doctor's patients without all the redirects and other disadvantages. The present inventor developed a novel solution that addresses many of the concerns of conventional online shopping systems—namely, the present inventor developed the multi-merchant gateway solution which is a micro-store 150 featuring related products. The following paragraphs concentrate on operation of the multi-merchant gateway solution and discuss how it solves many problems faced by merchants or businesses who wish to provide advertising for related products, merchandise and services.

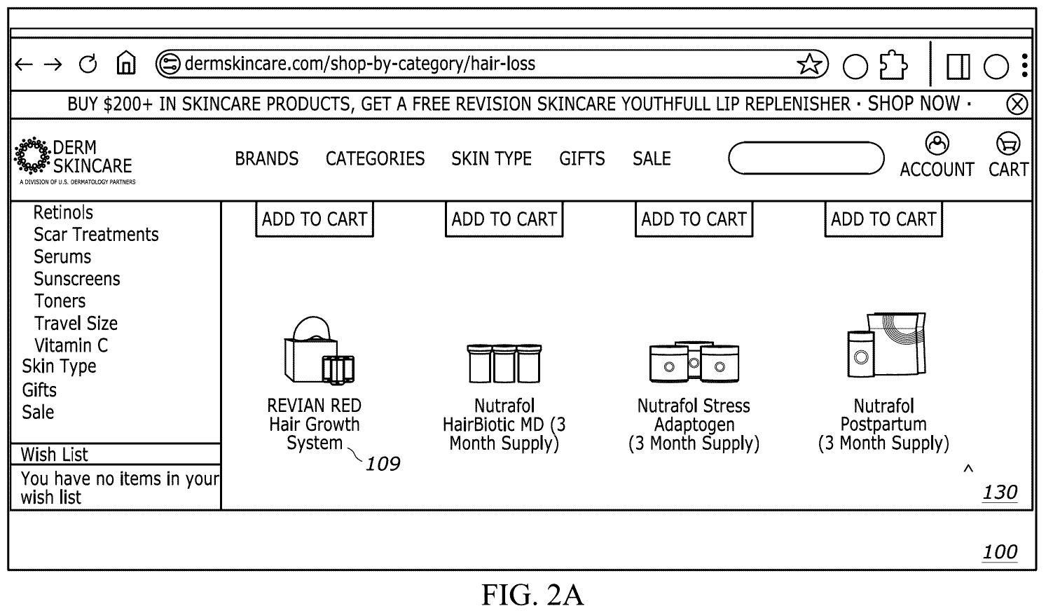

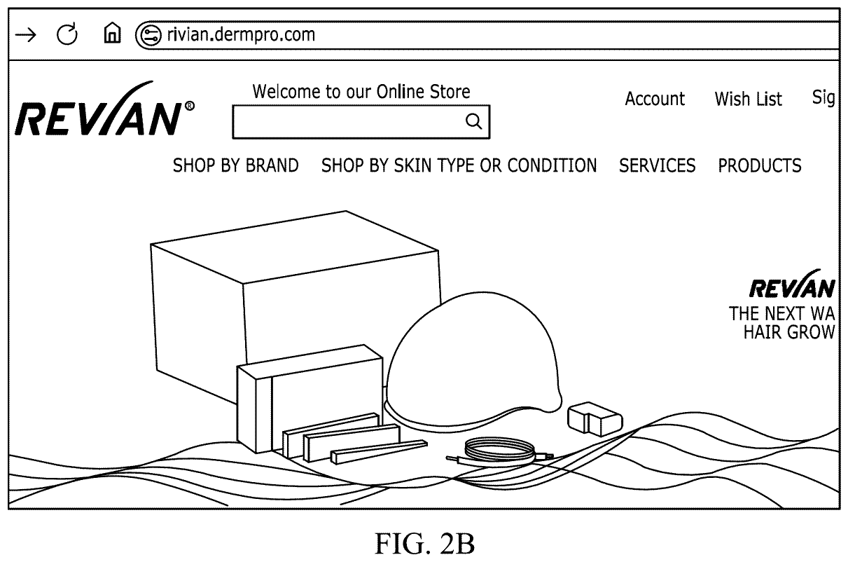

FIG. 2A depicts an example screenshot of a product advertisement 109 in an online merchant store 130 on the merchant website 100, according to various embodiments. In particular, the figure shows a product advertisement 109 for a hair growth product featured in the online store 130 of merchant website 100. (This type of hair growth product is sometimes called a “hair growth cap”, or simply a “cap”.) This product is offered to customers of the merchant who visit the merchant website 100, but the manufacturer of the product fulfills the orders via their warehouse in accordance with the multi-merchant gateway solution.

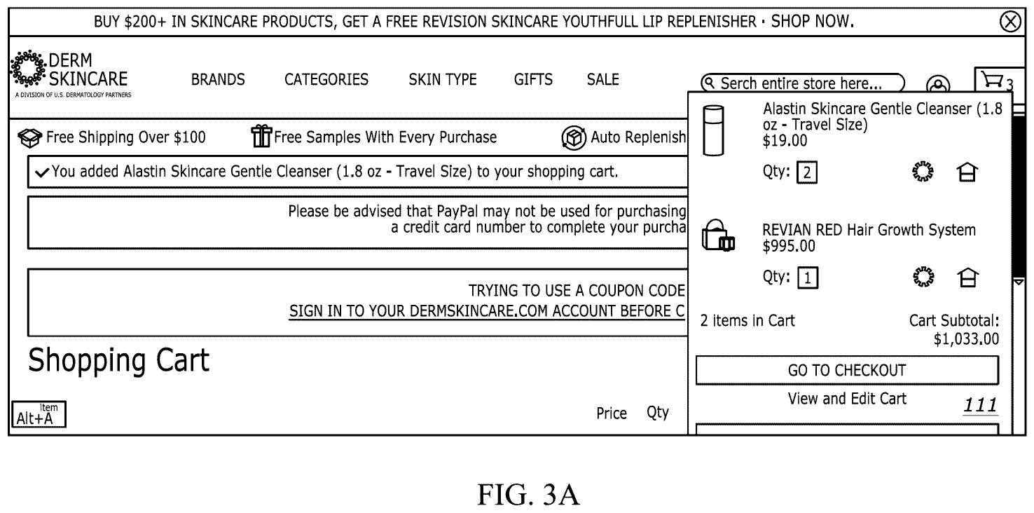

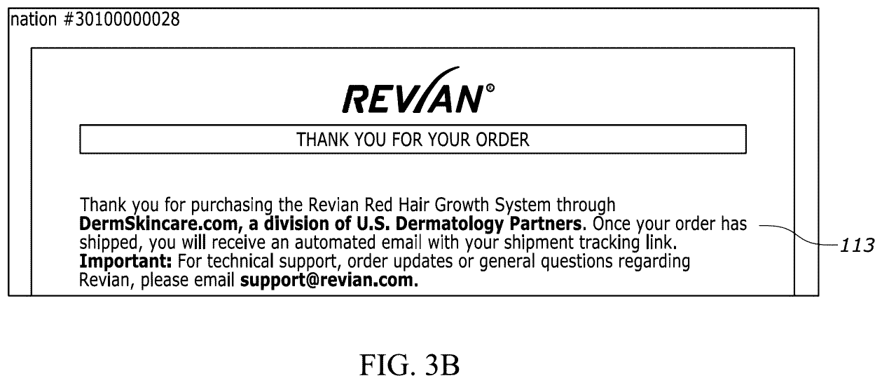

FIG. 3A depicts an online shopping cart screenshot 111 showing a customer purchasing multiple products from different manufacturers through a multi-merchant architecture website such as host webstore 200 of FIG. 1A, according to various embodiments. This may be done by providing each of the different manufacturers a micro-store on the website developer's platform (e.g., micro-stores 151/152/153 of FIG. 1A) that is integrated into all the website developer's websites that offer a given product—e.g., the hair growth cap product. FIG. 2B depicts an example screenshot of a hair growth cap as displayed at the manufacturer's micro-store on the website developer's platform. From the merchant's perspective, redirecting a customer from a merchant website to a website developer's micro-store is a much better situation than redirecting the customer to a manufacturer's website. A website developer has no incentive to steal the customer or take credit for any sales without sharing an incentive with the merchant. By contrast, the manufacturer stands to profit by either stealing the customer or solely taking credit for the sales.

To make payment processing more convenient the micro-stores typically have a merchant account for credit card processing. Further, the website developer can provide any payment mechanism offered by the merchants themselves, including for example, checks, ACH, credit cards, or a buy now pay later option. In one typical implementation a given product may have a micro-store on the website developer's platform that uses a Stipe® merchant account to capture the customer's transaction payment. The customer can either buy just that particular product, or they can purchase other items sold by the manufacturer of that product. In FIG. 3A the buyer is adding both a hair growth cap and another skincare product. In this example, these two products are produced by two different manufacturers, but sold in a single transaction-that is, they are listed in a single online shopping cart to enable a single purchase including both products.

As the customer goes through the purchase process, the cart experience includes a single purchase on one website—e.g., a micro-store on a website developer's platform, or the online store of a manufacturer such as US Dermatology® website. The transaction for all products of every manufacturer is completed with one credit card “swipe” at the time of purchase. The customer's transaction is then “split” on the backend between two payment gateways with two different amounts and two different payment gateways—one for each manufacturer. In some forms, the payment gateways for each micro-store are embedded in the checkout process. Upon checkout, the single payment of the user may go to a the financial institution split based on the micro-store of each individual product that was purchased. While the customer has a cart of different products from different manufacturers that are purchased with a single payment, the customers credit card receipt or the like will show each individual purchase itemized by manufacturer as if each was separately purchased from the website of each manufacturer.

A website developer such as DermPRO® can configure individual shipping and tax configurations and separate or restrict usage of a points program. For example, one manufacturer may offer a points program in their store, but those points are restricted only to purchasing their products and services. They can be restricted from being used for the purchase of another manufacturer's product. The website developer can configure the entire transaction to be declined if one of the transactions is declined or configure it such that only one transaction is declined, resulting in one or more other successful transactions.

FIG. 3B depicts an example order acknowledgement screenshot 113 for products from different manufacturers, in accordance with various embodiments. Providing clear messaging from both manufacturers to the customer helps to avoid confusion and possibly chargebacks. The site of one manufacturer—e.g., US Dermatology®—may be configured to say thank you for your purchase of our product and for the purchase of Revian® Red Cap through our Partner Revian®. The customer may also, or alternatively, receive an email from the Revian® store indicating the customer's purchase on the US Dermatology® site referencing the appropriate contact numbers, and notification of Revian, LLC on the credit card statement to ensure the customer is not under the impression that the receipt on their American Express®, Visa® or other credit card has a name which they don't recognize. Having clear messaging from both systems makes it less likely that the customer will contact their credit card company because then don't recognize the purchase on their credit card statement.

The order is submitted to the other manufacturer—e.g., to the Revian® warehouse—and the customer is notified throughout the process, from both Revian® and US Dermatology® to the progression of the shipment, details about returns, and any information to help steer the customer to the correct merchant for remediation. This system ensures that the customer's funds for the product or service bought are segregated from the other merchant, which allows the doctor the peace of mind that any returns or chargebacks will not affect the status of their merchant account or funds available that could impact operations. The second manufacturer in this transaction—e.g., Revian®—can also provide information about the product, their guarantee, their return policy, etc., which allows the manufacturer to ensure their standard operating procedures are adhered to, versus expecting the provider to relay such messaging.

The website developer—e.g., DermPRO®—can arrange to split the manufacturer's commission for the initial transaction with the provider, with the residual amount of the sale going to the manufacturer. For example, for a given sale, the website developer and the merchant may each receive agreed-upon percentages (e.g., 3% and 2%, or 7% and 8%, or other agreed-upon percentages), with the remainder of the transaction going to the manufacturer. The agreed upon commission amounts can be paid at the time of sale via multi-merchant technology, or can be held in an account and paid out on a periodic basis, e.g., a monthly payout.

The multi-merchant gateway can include numerous manufacturers in a single provider's multi-merchant architecture online store. This allows the provider to offer many different devices and products without investing in inventory or worrying about fulfillment with their customer never leaving their online store. They maintain control over the customer's experience and the marketing to that customer in their brand.

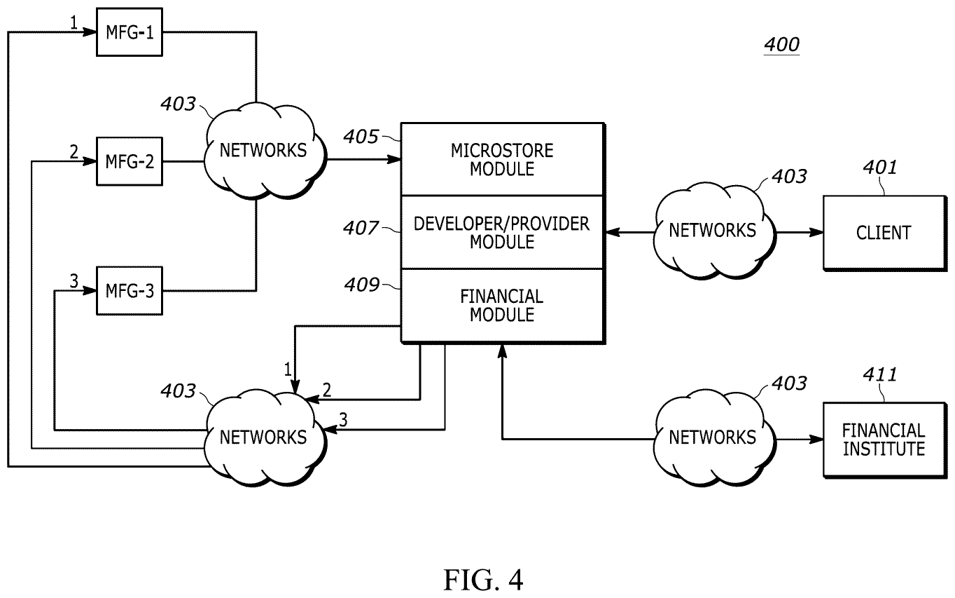

FIG. 4 depicts an example architecture 400 suitable for use in practicing the invention, in accordance with various embodiments. The architecture 400 depicts various manufactures (MFG-1, MFG-2, MFG-3) having products that the merchant webstore 200 wants to sell using the system that may be found via networks (such as the Internet) 403. The merchant selects various products to advertise and offer for sale in the webstore 200 and displays the products among other things in the developer/provider module the user interfaces. Although invisible to the user, there is a micro-store, or copy, of each of the manufacturers' website resident in the micro-store module 405.

A user accessing the system using client computer 410 via network 403 shops in the webstore 200 and selects items to purchase and puts them in the shopping cart. Upon checkout, the financial module includes a gateway for each of the micro-stores so payments for the individual products of each MFG purchase can be credited to the manufactures. While the user makes a single credit card “swipe,” the payment is split by the system to the appropriate parties and the user's credit card statement shows each individual manufacturer and the price paid to each individual manufacturer as if separate transactions occurred.

In operation, upon making a purchase of multiple products in an order from different companies—e.g., Mfg1, Mfg2 and Mfg3—a single payment is received for the total order cost. The financial module 409 coordinates with a financial institution 411 to receive the single payment. The single payment may be a credit card charge to a customer's credit card. Once the single payment is received the financial module 409 allocates it among the multiple vendor companies—e.g., Mfg1, Mfg2 and Mfg3. The developer/provider module 407 sends information about the order and user information including a user name and user shipping address to each of the multiple companies.

In response to receiving the user information, payment, and information about the order, each of the companies typically sends an order acknowledgement to the client computer of the customer. Each of the companies ships the product(s) for which they received payment to the customer.

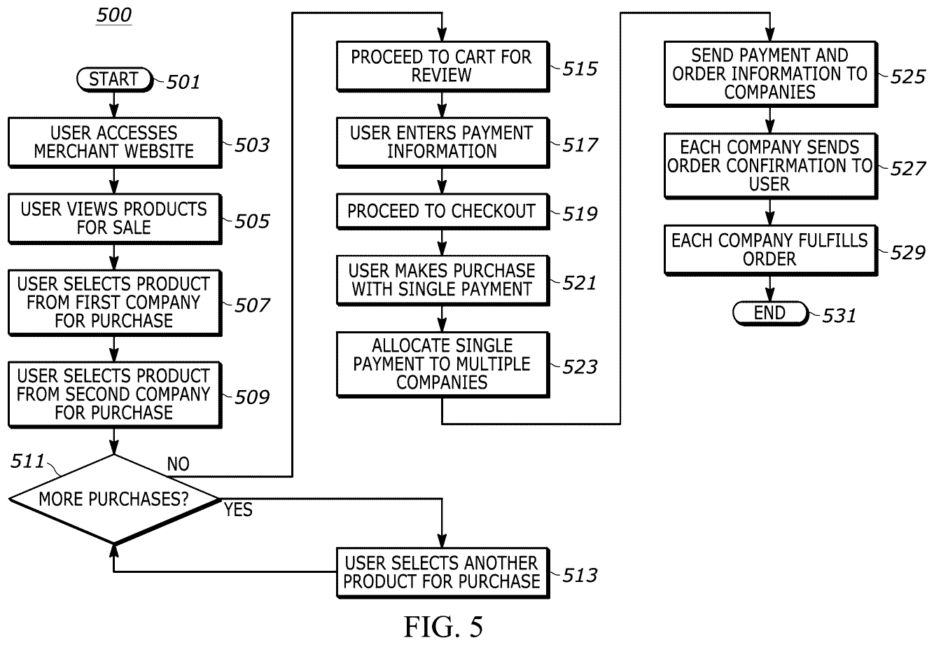

FIG. 5 is a flowchart 500 of a method of multi-company single-transaction purchases, in accordance with various embodiments. The method starts at block 501 and proceeds to block 503 where a user—that is, a customer or patient—access a merchant website. In block 505 the user browses the website, viewing various products offered for sale online on the merchant website—e.g., merchant website 100 of FIG. 1A. Typically, the products offered for sale on the merchant website are associated with the merchant's main line of business. The customer may also find a desired product by clicking on a brand-link that redirects the customer from the merchant website to a brand-specific micro-store such as micro-store 151 configured as part of host webstore 200 shown in FIG. 1A.

The method proceeds to block 507 where the user selects the product of a first company for purchase. In some embodiments the user may click on a link associated with the first product—for example, product link 101-1 shown in FIG. 1A—and be redirected to a product-type micro-store such as micro-store 150. The micro-store may be part of a manufacturer's website, a website developer's micro-store, or may be a distributor's website. Depending upon the details of the implementation, the user may either continue shopping in the host webstore 200 or be returned to the merchant website 100. Turning again to FIG. 5, in block 509 the user selects another product for purchase from a second company. Once again the user is redirected to a micro-store such as micro-stores 150-154 on host webstore 200 of FIG. 1A (unless the user was shopping a micro-store already). The method proceeds to block 511.

In block 511 it is determined whether the user wants to keep online shopping and buy more products. If the user does want to buy more products the method proceeds along the “YES” path to block 513 where the user selects another product. As with the first two purchased products the user may be redirected to a micro-store as described above to select the product for purchase. The method then returns to block 511. Upon determining in block 511 that no more purchases are to be made the method proceeds to block 515, allowing the user to review their online shopping cart which lists the products selected for purchase. Typically, in the cart the user can edit their purchase decisions by changing the quantity of items purchased or eliminating purchases. Information can also be provided regarding the multiple shipments the user will be receiving from the different companies.

In block 517 the user is prompted to enter payment information. Online payments may be achieved in several different manners, including for example, credit card payment, ACH payment, wire transfer payment, PayPal, or other like types of online payment systems known to those of ordinary skill in the art. The payment information typically includes an account number (e.g., credit card number), and contact information such as the address for delivery and a telephone number or email address of the customer. Upon completing block 517 the method proceeds to block 519. Once the user's delivery address is entered, the shipping costs, taxes (including state taxes, if any), and other handling costs are calculated to provide a total amount for payment. At this time an estimate of arrival time for each of the products can be provided to the user. The terms and conditions for the sale, delivery and warranty of each product may also be provided to the user at this time.

In block 519 the user proceeds to checkout. In checkout the user is typically prompted to make a purchase input (e.g., push an online button) to signify execution of the purchase. Once the user makes the purchase input the method proceeds to block 521. In block 521 an electronic payment is made for the purchase. It is significant that only a transaction is made (and a single checkout screen is displayed) for the multiple-brand purchase—that is, for multiple products from multiple brands (companies) to be purchased Once the transaction has been executed in block 521 to make the multiple-brand purchase, the method proceeds to block 523.

In block 523 an allocation calculator allocates the customer's payment for the multiple-brand purchase of the products among the multiple companies based on the costs and charges for the respective purchases. The amount for each company includes their product price plus shipping costs and any other taxes and/or handling costs that apply to the product(s) each company will be shipping. The allocated purchase amounts are then sent to each of the companies in block 525 along with payment and order information. The payment and order information includes the amount paid for each product, plus any applicable taxes, shipping and handling fees that are being sent to the company. The allocation calculator is typically a computer program, routine, code or other logic configured to allocate the total amount of the transaction-including any taxes, shipping costs or other handling costs-among the multiple companies that will be fulfilling the order.

In block 527 each company sends a confirmation message to the user. The confirmation message is generally sent by email, but could be sent by text message or any other means of communication agreed upon by the customer and the company. Typically, the confirmation message includes an estimate of when the product will arrive as well as tracking information that will allow the user to check on the shipping status of the product. The method proceeds to block 529 where each company fulfills the product order by shipping their product(s) to the user. Typically, once the product has been delivered, a confirmation message is sent saying that the product was delivered to the user's address on the delivery date. Information about possible product returns (e.g., due to a problem with the product or dissatisfaction by the user) may be included with the product. Upon delivery of the products the method proceeds to block 531 and ends.

The term “non-transitory,” as used herein, is intended to describe a computer-readable storage medium-that is, a “memory”-excluding propagating electromagnetic signals. A “non-transitory computer-readable storage medium” is not limited by any particular type of physical computer-readable storage device or memory. For instance, the term “non-transitory computer readable medium” encompasses various types of storage devices that may, or may not, store information permanently. Random access memory (RAM) is a type of non-transitory computer readable medium. Data stored on in a non-transitory computer readable medium may further be transmitted as an electrical or electromagnetic signal via a transmission media such as a fiber optic cable, a network and/or a wireless link. The term “non-transitory,” as used herein, is a limitation of the medium itself (i.e., a tangible storage medium, not a signal) as opposed to a limitation on data storage persistency (e.g., RAM vs. ROM).

A “website” is a collection of files accessed through an internet web address, covering a particular theme or subject, and managed by a particular person or organization. The opening page of a website is called a home page. A web address—also called a URL (Uniform Resource Locator)—is a unique identifier used to locate a resource on the internet.

A “merchant business” is a business with a primary line of business other than retail sales or wholesale distribution. A “merchant website” is the website of a merchant business that sells one or more third-party products related to the primary line of business of the merchant business. The product(s) may be goods—e.g., sports equipment, clothing, food items, etc.—or may be services-e.g., medical care, tax preparation, tennis lessons-or a combination of goods and services. The merchant website has the merchant business' name or logo on the homepage, and a description of the business somewhere on the website (e.g., description of the primary line of business, the street address or contact information such as a phone number or email address). Retail sellers (e.g., Walmart, Safeway or Amazon) or wholesale distributors (e.g., Wholesale Central, Dot Foods) are not considered merchant businesses in regards to the definition of “merchant website” because the primary line of business of a retail seller or a wholesale distributor is to sell and distribute products.

A “third-party product” of a merchant business is a product that is not produced by the merchant business, but is related to the primary line of business of the merchant business and is sold by the merchant business. For example, a hair growth product (e.g., the Revian Red Cap of FIG. 3B) sold by a medical clinic would be a third-party product of the medical clinic.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

1. A method of multiple-brand internet online shopping comprising:
configuring a micro-store as part of a host webstore, the micro-store including a first description of a first product offered for sale to a user for a first price, wherein the first product is produced by a first company;
including a second description of a second product offered for sale on-line to the user at a second price, wherein the second product is a third-party product produced by a second company;
configuring an on-line cart as part of the host webstore, the on-line cart being configured to display an order including a first listing of the first product being purchased and a second listing of the second product being purchased, the on-line cart also displaying a total order cost including the first price of the first product and the second price of the second product;
prompting the user a checkout page to make a purchase-input;
executing a single transaction in response to the purchase-input for the first product and the second product, the single transaction including the total order cost as payment for the first product and the second product; and
allocating a first portion of the total order cost to the first company and a second portion of the total order cost to the second company.

2. The method of claim 1, further comprising:
configuring a merchant website of a merchant business, the merchant website including a listing of the first product offered for sale at the first price, wherein the first product is a third-party product of the merchant business.

3. The system of claim 2, further comprising:
providing a first link on the merchant website included in the listing of the first product, the first link being configured to redirect the user to the micro-store on the host webstore.

4. The method of claim 3, wherein the host webstore is a web developer host webstore.

5. The method of claim 1, further comprising:
configuring a landing page as part of the web developer host webstore; and
providing identifying information of the merchant business on the landing page.

6. The method of claim 1, wherein the total order cost includes a first shipping cost for shipping the first product from the first company to the user and a second shipping cost for shipping the second product from the second company to the user.

7. The method of claim 6, wherein the single transaction results in a first credit card payment to the first company and a second credit card payment to the second company.

8. The method of claim 6, wherein the single transaction results in a single credit card payment to the host webstore, and the host webstore sends the first portion of the single payment to the first company and sends the second portion of the single payment to the second company.

9. The method of claim 8, further comprising:
prompting the user to enter user information at a cart page, the user information including a user name and user shipping address.

10. The method of claim 9, further comprising:
sending a first package containing the first product from the first company to the user at the user shipping address; and
sending a second package containing the second product from the second company to the user at the user shipping address.

11. A multiple-brand internet online shopping system stored on one or more non-transitory computer readable storage mediums, the system comprising:
a micro-store configured as part of a host webstore, the micro-store including a first description of a first product offered for sale to a user for a first price, wherein the first product is produced by a first company;
a second description of a second product offered for sale on-line to the user at a second price, wherein the second product is a third-party product produced by a second company;
an on-line cart configured as part of the host webstore, the on-line cart being configured to display an order including a first listing of the first product being purchased and a second listing of the second product being purchased, the on-line cart also displaying a total order cost including the first price of the first product and the second price of the second product;
a checkout page prompting the user to make a purchase-input to execute a single transaction for the first product and the second product, the single transaction including the total order cost as payment for the first product and the second product; and
an allocation calculator configured to allocate a first portion of the total order cost to the first company and a second portion of the total order cost to the second company.

12. The system of claim 11, further comprising:
a merchant website of a merchant business, the merchant website including a listing of the first product offered for sale at the first price, wherein the first product is a third-party product of the merchant business.

13. The system of claim 12, further comprising:
a first link on the merchant website included in the listing of the first product, the first link being configured to redirect the user to the micro-store on the host webstore.

14. The system of claim 13, wherein the host webstore is a web developer host webstore.

15. The system of claim 11, further comprising:
a landing page configured as part of the web developer host webstore, wherein the landing page has identifying information of the merchant business.

16. The system of claim 11, wherein the total order cost includes a first shipping cost for shipping the first product from the first company to the user and a second shipping cost for shipping the second product from the second company to the user.

17. The system of claim 16, wherein the single transaction results in a first credit card payment to the first company and a second credit card payment to the second company.

18. The system of claim 16, wherein the single transaction results in a single credit card payment to the host webstore, and the host webstore sends the first portion of the single payment to the first company and sends the second portion of the single payment to the second company.

19. The system of claim 18, further comprising:
a cart page prompting the user to enter user information including a user name and user shipping address.

20. The system of claim 19, further comprising:
a first package containing the first product sent from the first company to the user at the user shipping address; and
a second package containing the second product sent from the second company to the user at the user shipping address.
